(19) United States
(12) Patent Application Publication
(10) Pub. No.: US 2025/0313201 A1
(43) Pub. Date: Oct. 9, 2025

(54) CONTEXT DETERMINATION BY CAN ODOMETRY

(71) Applicant: VALEO SCHALTER UND SENSOREN GMBH, Bietigheim-Bissingen (DE)

(72) Inventor: Thomas Heitzmann, Troy, MI (US)

(73) Assignee: VALEO SCHALTER UND SENSOREN GMBH, Bietigheim-Bissingen (DE)

(21) Appl. No.: 18/627,954

(22) Filed: Apr. 5, 2024

(51) Int. Cl. B60W 30/14; B60W 50/14

(52) U.S. Cl. CPC B60W 30/146; B60W 50/14; B60W 2050/146; B60W 2420/403; B60W 2520/06; B60W 2540/18; B60W 2555/60

(57) ABSTRACT

A method for operating a vehicle includes capturing an image frame and odometry data associated with a vehicle as the vehicle traverses an external environment. The image frame and odometry data are transmitted to an Electronic Control Unit (ECU) of the vehicle. The method further includes determining a local speed limit for the vehicle from the image frame of the external environment and selecting a context of the external environment based upon the odometry data. A global speed limit for the vehicle is determined based upon the selected context. An arbitrated speed limit, which is the local speed limit or the global speed limit, is notified to a driver of the vehicle.

### BACKGROUND

In order to ensure the safety of its citizens, government authorities will often place limitations on how fast a vehicle may travel on a particular road or other paved surface. These limitations, referred to as “speed limits”, are determined based upon the location of the paved surface. For example, a paved surface in a heavily trafficked area (i.e., a city) will have a lower speed limit than a paved surface in a remote area (i.e., a countryside).

Due to the fact that a speed limit is imposed to ensure the safety of citizens in the vicinity of a vehicle, it is imperative that the vehicle is able to correctly display the speed limit to a driver of the vehicle. However, this endeavor may prove challenging, as it is possible that a sign depicting the speed limit is obstructed due to weather conditions. Thus, it is desirable to be able to determine a speed limit that can be displayed to the user in cases where a speed limit sign is not detected by a vehicle.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method for operating a vehicle includes capturing an image frame of an external environment of a vehicle. The method also includes capturing odometry data associated with a vehicle as the vehicle traverses an external environment. The image frame and odometry data are transmitted to an Electronic Control Unit (ECU) of the vehicle. The method further includes determining a local speed limit for the vehicle from the image frame of the external environment and selecting a context of the external environment based upon the odometry data. A global speed limit for the vehicle is determined based upon the selected context. An arbitrated speed limit, which is determined as the local speed limit or the global speed limit, is notified to a driver of the vehicle.

A vehicle includes at least one image sensor, at least one encoder, an Electronic Control Unit (ECU), a display, and a data bus. The image sensor captures an image frame of an external environment of the vehicle as the vehicle traverses the external environment. The encoder captures odometry data associated with the vehicle as the vehicle traverses the external environment. The data bus transmits the image frame and the odometry data to the ECU. The ECU determines a local speed limit for the vehicle from the image frame of the external environment, selects a context of the external environment based upon the odometry data, and determines a global speed limit for the vehicle based upon the context. The ECU also determines an arbitrated speed limit as the local speed limit or the global speed limit. The display notifies a driver of the vehicle of the arbitrated speed limit.

Any combinations of the various embodiments and implementations disclosed herein can be used in a further embodiment, consistent with the disclosure. Other aspects and advantages of the claimed subject matter will be apparent from the following description and the claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 depicts a vehicle in accordance with one or more embodiments disclosed herein.

FIG. 2 depicts a flowchart of a process in accordance with one or more embodiments disclosed herein.

FIGS. 3A-3D depict examples of a motor vehicle traversing different environments in accordance with one or more embodiments disclosed herein.

FIG. 4 depicts a hardware overview of a vehicle in accordance with one or more embodiments disclosed herein.

FIG. 5 depicts a flowchart of a process in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, one or more embodiments of the invention as described herein are directed towards a system including a vehicle. The vehicle has at least one camera that is coupled to an Electronic Control Unit (ECU). The camera(s) capture images of the local environment of the vehicle, and the ECU extracts speed limit signs and their constituent values from the captured images. Simultaneously, the ECU receives vehicle odometry data related to the motion of the vehicle, and determines a global speed limit associated with the surrounding environment. Subsequently, the ECU outputs an arbitrated speed limit to a display device to be displayed to the driver, where the arbitrated speed limit is equivalent to the global speed limit or the local speed limit.

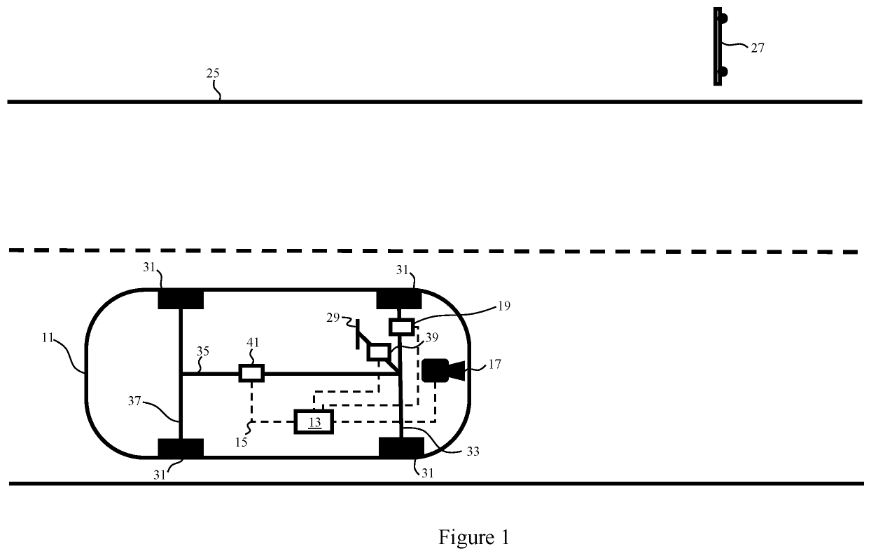

FIG. 1 depicts an example of a vehicle 11 in accordance with one or more embodiments disclosed herein. The vehicle 11 may be a passenger car, a mass transit vehicle such as a motorcoach, a transportation vehicle such as a semi-truck, or any other type of vehicle 11. In addition, the vehicle 11 may be powered by a battery, such as an electric vehicle, or an internal combustion engine without departing from the nature of this disclosure. The vehicle 11 is depicted in FIG. 1 as traveling on a paved surface 25 that is representative of infrastructure such as a highway, parking lot, or city street, for example.

To drive through the external environment, the vehicle 11 includes physical components such as tires 31, a front axle 33, a driveshaft 35, and a rear axle 37. The tires 31 disposed at the front portion of the vehicle 11 are connected by the front axle 33, and the tires 31 disposed at the rear portion of the vehicle 11 are connected by the rear axle 37. Similarly, the driveshaft 35 connects the front axle 33 to the rear axle 37. Each of the front axle 33, the driveshaft 35, and the rear axle 37 may be formed as a metal rod, for example, and collectively serve to transmit motion generated by an engine (not shown) of the vehicle 11 to the tires 31. In addition, the front axle 33 is coupled to a steering wheel 29, which is a driver-actuated handle that controls a rotation of the front axle 33, and thus the tires 31 and the vehicle 11.

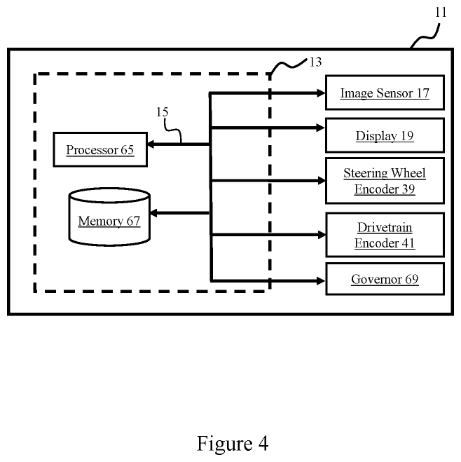

As shown in FIG. 1, a vehicle 11 includes an Electronic Control Unit (ECU) 13. The structure of the ECU 13 is further detailed in relation to FIG. 4, but generally includes one or more processors, integrated circuits, microprocessors, or equivalent computing structures. The ECU 13 is thus configured to execute a series of instructions, formed as computer readable code, that allow the ECU 13 to receive and interpret data from a plurality of sources. The computer readable code may, for example, be written in a language such as C++, C#, Java, MATLAB, Python, or equivalent computing languages suitable for motor vehicle control instructions.

The ECU 13 is connected to various components of the vehicle 11 by way of a data bus 15. The data bus 15 includes a series of wires, optical fibers, printed circuits, or equivalent structures that form electrical pathways for transmitting signals between devices of the vehicle 11. On the other hand, the devices connected to the ECU 13 include an image sensor 17, a display 19, a steering wheel encoder 39, and a drivetrain encoder 41. Other sensors and devices may be connected to the ECU 13 without departing from the nature of this specification.

The image sensor 17 is depicted as being a camera in FIG. 1. To facilitate capturing an image and as is commonly known in the art, a camera includes a lens that focuses light beams onto a series of photocells. The photocells are, in turn, excited by the focused light beams, and output voltage signals that correspond to the frequencies of the received light beams. In this way, the camera is configured to derive the color of a particular light beam based upon the response of a photocell struck by the light beam. By combining the output voltage values from the multiple photocells into a matrix array, the camera is capable of forming an image of the surrounding environment. Thus, as a whole, the image sensor 17 is configured to capture an image frame that includes a view of a physical object located in the external environment of the vehicle 11. Additionally, although the image sensor 17 is described above as comprising a camera, the image sensor 17 may alternatively be embodied as a Light Detection and Ranging (LiDAR), radar, or equivalent sensor known to a person of ordinary skill in the art. Furthermore, because a video feed is a collection of images captured in rapid succession, the image sensor 17 is configured to capture a video feed of the external environment as well.

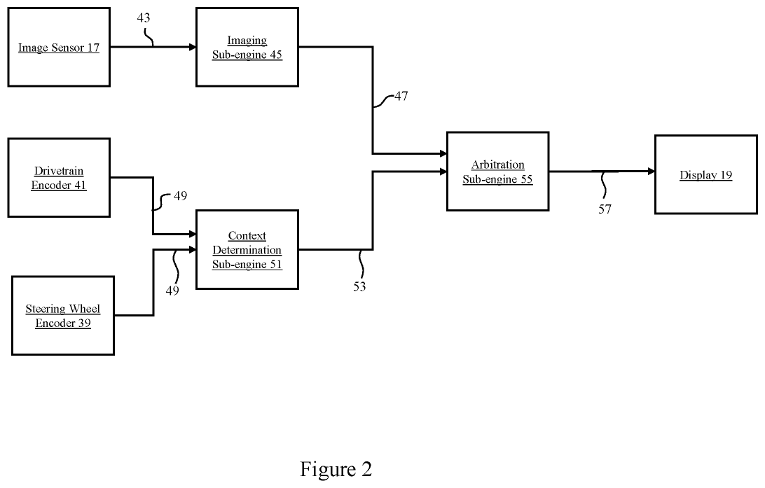

As further shown in FIG. 1, the surrounding environment of the vehicle 11 includes the paved surface 25 and a sign 27. The sign 27 displays a local speed limit (e.g., FIG. 2) to the driver of the vehicle 11, and may be practically embodied as a fiberglass sign attached to a metal post, or equivalent. As the vehicle 11 is traversing the paved surface 25, the image sensor 17 captures an image of the external environment and thus the sign 27. The image is subsequently passed to the ECU 13 by way of the data bus 15, and the ECU 13 extracts the local speed limit (e.g., FIG. 2) depicted on the sign 27 from the captured image as is further discussed below.

However, and as noted above, the sign 27 may be obscured by local weather conditions or in need of repair. Alternatively, the sign 27 may have been intentionally vandalized by a malicious party with the intent to fool a driver of the vehicle 11. As a third example, the vehicle 11 may have traveled a lengthy distance from the sign 27, and may be unsure if the speed limit depicted by the sign 27 is accurate. In such cases, it is beneficial for the vehicle 11 to determine a global speed limit (e.g., FIG. 2) based upon the context of the external environment, and display the global speed limit (e.g., FIG. 2) to the driver in place of the local speed limit (e.g., FIG. 2) depicted by the sign 27. As used herein, the term “global speed limit” refers to a maximum speed limit of a paved surface 25 imposed by a governmental authority based on the infrastructure of the external environment, and exists in addition to the local speed limit (e.g., FIG. 2) depicted on the sign 27.

For example, a vehicle 11 may be traversing a paved surface 25, and the sign 27 depicts that the local speed limit (e.g., FIG. 2) of the paved surface 25 is 50 Kilometers Per Hour (KPH). The paved surface 25 cuts through a countryside or rural area, and an authority that governs the land occupied by the paved surface 25 has determined that all rural roadways have a global speed limit (e.g., FIG. 2) of 70 KPH. Thus, the paved surface 25 is associated with two speed limits: a local speed limit (e.g., FIG. 2) of 50 KPH and a global speed limit (e.g., FIG. 2) of 70 KPH.

The global speed limit (e.g., FIG. 2) is derived based upon the context of the external environment. The term “context” as recited herein relates to a semantic classification of the surrounding environment of the vehicle 11. For example, a “city” context is an environment that includes human-made attractions such as businesses, restaurants, and social meeting points. Similarly, a “residential” context relates to a location where houses border the paved surface 25, such as a neighborhood. A “countryside” or “rural” context describes a remote area and may include features such as livestock, crops, natural flora and fauna, etc. A “highway” context refers to a paved surface 25 that is exclusively designated for high speed travel, and may include features such as concrete barriers (colloquially referred to as a “jersey barrier”) bordering the lanes. On the other hand, a “parking” context refers to a paved surface 25 with numerous lines demarcating parking slots for temporarily stopping a vehicle 11. The use of the term “context” is not limited to the various examples described above, and it will be appreciated that a vehicle 11 may capture data related to other contexts without departing from the nature of this disclosure.

Continuing with FIG. 1, the vehicle 11 includes encoders that capture odometry data of the motion of the vehicle 11. Specifically, the encoders of the vehicle 11 include a steering wheel encoder 39 and a drivetrain encoder 41. As is commonly known in the art, an encoder is a device that outputs an electrical signal that corresponds to motion. An encoder may operate using a hall effect sensor (not shown) and a magnet (not shown), where the magnet is attached to the moving body and the hall effect sensor captures variations in the strength of the magnetic field produced by the magnet. Alternatively, the encoder may operate using a Light Emitting Diode (LED) (not shown), a slotted disk (not shown) coupled to the moving body, and a photovoltaic cell (not shown). In this case, the LED transmits a focused light beam to the photovoltaic cell through the slots of the moving disk, and the photovoltaic cell outputs a signal corresponding to the time at which the light beam excites the cell. Accordingly, the phrase “encoder” is not limited to a particular type of encoder, and other types of encoders may be substituted for the encoders discussed above. Additionally, the drivetrain encoder 41 and the steering wheel encoder 39 may be different types of encoders or the same type of encoder without departing from the nature of this disclosure.

Functionally, the steering wheel encoder 39 serves to capture an angle of rotation of the steering wheel 29, which is actuated by a driver of the vehicle 11 as discussed above. As discussed herein, the angle of rotation of the steering wheel 29 forms time-series trajectory data comprised in odometry data of the vehicle 11, as the steering wheel 29 itself controls the direction of motion of the vehicle 11. Similarly, the drivetrain encoder 41 serves to capture a number of rotations of the driveshaft 35, and is practically embodied as a Vehicle Speed Sensor (VSS). Because the driveshaft 35 is connected to the tires 31 of the vehicle 11, the number of rotations of the driveshaft 35 directly corresponds to the velocity, or speed, of the vehicle 11. Thus, the number of rotations of the driveshaft 35 forms velocity data comprised in odometry data of the vehicle 11, and, by correlating the velocity data to the amount of elapsed time that the data is captured, a travel distance of the vehicle 11 is determined. Alternatively, the drivetrain encoder 41 may capture the number of rotations of the tires 31, a crankshaft (not shown) of an engine (not shown) of the vehicle 11, the front axle 33, the rear axle 37, or any other moving part of the vehicle 11. Data captured by the steering wheel encoder 39 and the drivetrain encoder 41 is stored in the ECU 13 in the form of a lookup table (e.g., Table 1).

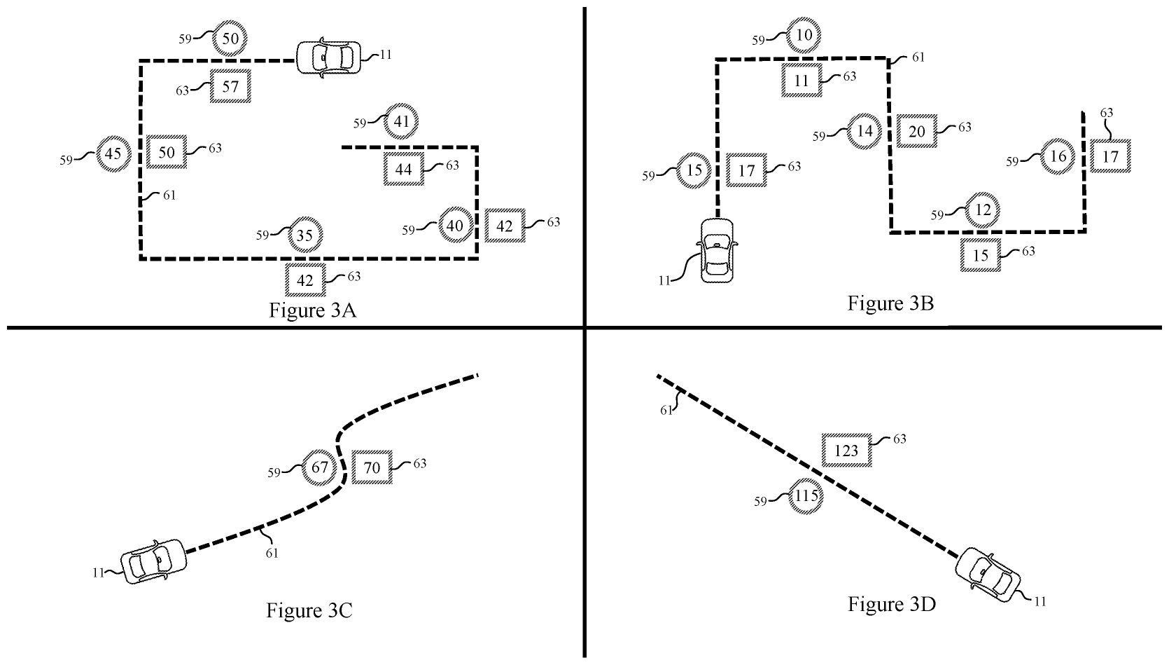

The steering wheel encoder 39 and the drivetrain encoder 41 serve to provide odometry data to the ECU 13, and the ECU 13 determines the context of the external environment based upon the odometry data. Detailed examples of various contexts are described in relation to FIGS. 3A-3B below. In general, each context is associated with predetermined thresholds or values related to the velocities and the number of turns of the vehicle 11 as the vehicle 11 traverses the external environment. Thus, by analyzing the odometry data provided by the steering wheel encoder 39 and the drivetrain encoder 41, the ECU 13 is configured to determine the context of the external environment of the vehicle 11. Once the context of the external environment is determined by the ECU 13, the ECU 13 determines the global speed limit (e.g., FIG. 2) of the external environment from the derived context.

Once the global speed limit (e.g., FIG. 2) and the local speed limit (e.g., FIG. 2) are determined, the ECU 13 performs a speed limit arbitration process to determine an arbitrated speed limit. The arbitrated speed limit (e.g., FIG. 2) is output by the ECU 13 to a display 19 in the cabin (not shown), or user compartment, of the vehicle 11. Example embodiments of the display 19 include a Liquid Crystal Display (LCD), Organic Light Emitting Diode (OLED), or equivalent displays capable of presenting graphics or text to a user. The display 19 is typically positioned behind the steering wheel 29 within the cabin (not shown), and allows the driver to visually verify information related to the operation of the vehicle 11. That is, in addition to the arbitrated speed limit, the display 19 presents information to the driver such as the speed of the vehicle 11 and the engine rotation speed of the vehicle 11, for example. By outputting the arbitrated speed limit (e.g., FIG. 2) to the driver of the vehicle 11, embodiments of the invention are advantageously configured to output a consistent and accurate speed limit to the driver in situations where the speed limit cannot be derived exclusively from the sign 27.

Turning to FIG. 2, FIG. 2 depicts a process for determining and outputting an arbitrated speed limit 57 to a display 19. The process depicted in FIG. 2 may be completed with various hardware components of a vehicle 11 as discussed in relation to FIG. 1. Alternatively, the process depicted in FIG. 2 may include additional computing hardware or vehicle hardware not discussed herein for the sake of brevity.

Initially, an image sensor 17 captures an image frame 43 of the external environment of the vehicle 11. The image frame 43 is a collection of pixels representing the external environment, and includes a sign 27 disposed in the external environment. The image frame 43 is transmitted from the image sensor 17 to an imaging sub-engine 45 that is stored on a memory (e.g., FIG. 4) of the ECU 13. The imaging sub-engine 45 is formed by computer readable code related to algorithms and functionalities further discussed below. As discussed above, the computer readable code may, for example, be written in a language such as C++, C#, Java, MATLAB, Python, or equivalent computing languages suitable for motor vehicle control instructions.

Generally, the imaging sub-engine 45 is configured to extract the value of a speed limit depicted on the sign 27. To achieve this function, the imaging sub-engine 45 is embodied, by way of nonlimiting examples, as an Optical Character Recognition (OCR) program or a Convolutional Neural Network (CNN). When embodied as an OCR program, the imaging sub-engine 45 uses pattern matching functions to extract numbers forming a speed limit posted on a sign 27. Alternatively, in the case of being embodied as a CNN, the imaging sub-engine 45 applies a series of convolution and pooling layers to an input image frame 43 to extract features (e.g., the numbers forming the speed limit on the sign 27) from the environment of the vehicle 11. Thus, overall, the imaging sub-engine 45 functions to derive a speed limit of the external environment of the vehicle 11 by analyzing an image frame 43 captured by an image sensor 17.

In conjunction with determining the speed limit of the vehicle 11, the imaging sub-engine 45 also assigns a confidence weight to the speed limit. The confidence weight associated with the speed limit allows the ECU 13 to determine the likelihood that a particular speed limit is a valid speed limit by way of a speed limit arbitration process, as further discussed below. Generally, a confidence weight is a decimal value ranging from 0-1, inclusive. A low confidence weight is assigned to poorly detected speed limits, such as cases where a sign 27 has been vandalized and is no longer easily discernible. On the other hand, a high confidence weight is assigned to detected speed limits that are easily recognizable by the ECU 13, such as cases where a speed limit is detected on a traffic-free road during the daytime, for example. Once the imaging sub-engine 45 has determined a speed limit from sign 27 and assigned a confidence weight to the determined speed limit, the imaging sub-engine 45 outputs the determined speed limit and the associated confidence weight as a local speed limit 47.

In addition, determined confidence weights associated with the speed limit may vary as a function of distance. In this regard, the imaging sub-engine 45 is configured to decrease a confidence weight associated with a determined speed limit as the distance increases between the location of the speed limit determination and the current location of the vehicle. For example, a speed limit extracted from a sign 27 may be associated with a confidence weight of 1.0, indicating a high confidence in the extracted speed limit. After the vehicle 11 has traversed a predetermined distance in which the imaging sub-engine 45 has not detected an additional sign 27, the imaging sub-engine 45 reduces the confidence weight to a value of 0.9, indicating that the imaging sub-engine 45 is less confident in the determined local speed limit 47 still being applicable to the vehicle 11. The rate of confidence weight decay as a function of distance is determined by a manufacturer of the vehicle 11, where the rate of decay may be a linear or non-linear function.

Simultaneous to detecting the local speed limit 47, the ECU 13 also determines a context of the external environment and a global speed limit 53 associated with the determined context. This process initiates by capturing Controller Area Network (CAN) data 49 with the steering wheel encoder 39 and the drivetrain encoder 41. As discussed above in relation to FIG. 1, the steering wheel encoder 39 captures a rotation angle of a steering wheel 29 of a vehicle 11, and the drivetrain encoder 41 captures a number of rotations of a driveshaft 35 of the vehicle 11. Thus, the CAN data 49 provided by the steering wheel encoder 39 is the rotation angle of the steering wheel and the CAN data 49 provided by the drivetrain encoder 41 is the number of rotations of the driveshaft 35, which forms the odometry data of the vehicle 11 discussed herein.

The CAN data 49 is transmitted from the steering wheel encoder 39 and the drivetrain encoder 41 to a context determination sub-engine 51 of the ECU 13. Similar to the imaging sub-engine 45, the context determination sub-engine 51 is formed of computer readable code, and may be written in languages such as C++, C#, Java, MATLAB, Python, or equivalent computing languages. For its part, the context determination sub-engine 51 derives the context of the local environment of the vehicle 11 from the CAN data 49 as further discussed below.

In particular, the context of the external environment is determined from the odometry information of the vehicle 11 captured in the CAN data 49. As discussed above, the phrase “context” refers to a term or phrase that semantically represents the local environment of the vehicle 11. Thus, the context of the external environment is derived based on CAN data 49 including steering wheel 29 angles and a number of rotations of a driveshaft 35, which represents the actualized motion of the vehicle 11 through the external environment.

Specific context derivation examples are provided below in relation to FIGS. 3A-3D, and a general description of the context derivation process is briefly provided as follows for the sake of clarity. Once the CAN data 49 is captured by the steering wheel encoder 39 and the drivetrain encoder 41, the CAN data 49 is transmitted by the data bus 15 to a lookup table (e.g., Table 1) stored on a memory (e.g., FIG. 4) of the ECU 13. The ECU 13 proceeds to compare the captured CAN data 49 to predetermined threshold values associated with potential contexts, and determines the actual context of the external environment to be the same as a context associated with the predetermined values closest to the CAN data 49. In this regard, the context determination sub-engine 51 may utilize a classification algorithm such as K-nearest neighbors or a SoftMax function to determine if a particular instance of CAN data 49 is related to a specific context. Alternatively, each context may be associated with predetermined thresholds related to the average speed, maximum speed, and number of turns of the vehicle 11, and the context may be determined by comparing the CAN data 49 to the predetermined thresholds.

As an additional alternative embodiment, the context determination sub-engine 51 may be embodied as a Recurrent Neural Network (RNN). In this case, the RNN embodying the context determination sub-engine 51 is fed examples of CAN data 49 and associated contexts during a training phase, and the RNN forms complex relationships between the CAN data 49 and the associated contexts. Specifically, the RNN is formed by neurons, or functions that compute a weighted resultant value from an input or series of inputs to provide an output value. By adjusting the weights forming the RNN (through backpropagation, for example) the RNN is trained to form the complex relationships between the CAN data 49 and the associated contexts. Subsequently, when the vehicle 11 is driving through the external environments, the RNN utilizes CAN data 49 provided by the vehicle 11 and the complex relationships formed during the training phase to determine the context of the external environment.

The output of the context determination sub-engine 51 is a global speed limit 53. In juxtaposition to the local speed limit 47, which represents a posted speed limit extracted from a sign 27, the global speed limit 53 represents the maximum speed limit of the context of the local environment. Thus, while the local speed limit 47 may only apply to a portion of the context, or may vary over the entirety of a context, the global speed limit 53 is directly associated with the context and only changes when the context of the external environment changes. For example, a residential context may be governed by a global speed limit 53 of 40 KPH, which is assigned by a government authority and is applicable to every residential context in the country that the vehicle 11 is traversing. Continuing with the example, the residential context may include a school zone (not shown), and the local community has posted a local speed limit 47 of 25 KPH to reduce the speed of vehicles 11 approaching the school zone. After the school zone, the local community may change the local speed limit 47 to a local speed limit 47 of 40 KPH to match the global speed limit 53. Thus, in the example presented above, the global speed limit 53 will consistently be 40 KPH for the entire residential context, and the local speed limit 47 will be either 25 KPH or 40 KPH depending on the position of the vehicle 11 in the residential context.

It is also entirely possible that the context of the external environment will change, and the local speed limit 47 may be retained throughout the change in context. For example, a vehicle 11 may be traveling in a “highway” context with a global speed limit 53 of 115 KPH. However, in this example the highway (not shown) that the vehicle 11 is traveling upon is under construction, and the local speed limit 47 posted on a sign 27 is 70 KPH to provide a safer driving environment through the construction zone. Subsequently, the vehicle 11 may exit the highway (not shown), and enter a “rural” context with a global speed limit 53 of 70 KPH. The rural street the vehicle 11 is traversing also has a local speed limit 47 of 70 KPH to match the maximum speed limit allowed by the governing entity. Thus, in the example provided above, the context of the external environment changes and the global speed limit 53 is adjusted to match the new context. However, because the vehicle 11 was traveling through the construction zone in the highway context with a slower speed than usual, the local speed limit 47 of the vehicle 11 is 70 KPH despite the change in contexts.

In addition to determining a context of the external environment based on the CAN data 49, the context determination sub-engine 51 also assigns a confidence weight to an output global speed limit 53. Similar to the process performed by the imaging sub-engine 45 and as discussed above, a weight applied to the global speed limit 53 may have values ranging from 0-1, inclusive. A small weight value (i.e., 0) indicates that the context determination sub-engine 51 has a relatively low confidence in the determined context and a large value (i.e., 1) implies that the context determination sub-engine 51 is very confident in the determined context. Thus, the global speed limit 53 output by the context determination sub-engine 51 includes a particular speed limit governing the current context of the external environment and a weight associated with the particular speed limit. As discussed herein, a weight associated with the local speed limit 47 is referred to as a “local speed limit weight” and a weight associated with the global speed limit 53 is referred to as a “global speed limit weight”. An example of a lookup table storing CAN data 49, the derived context, and the associated global speed limit and weight are presented in the below Table 1.

TABLE 1

| Dist. | Total Turns | Avg. Speed | Max Speed | | GSL | | Global Speed | |
|---|---|---|---|---|---|---|---|---|
| (km) | (#) | (KPH) | (KPH) | | Weight | Context | Limit (KPH) | |
| 0-0.5 | 0 | 115 | 120 | KPH | 1.0 | Highway | 115 | KPH |
| 0.5-1.0 | 1 | 115 | 115 | KPH | 0.9 | Highway | 115 | KPH |
| 1.0-1.5 | 2 | 85 | 115 | KPH | 0.2 | Rural | 70 | KPH |
| 1.5-2.0 | 4 | 70 | 72 | KPH | 0.7 | Rural | 70 | KPH |

Within Table 1, the distance, total turns, average speed, and max speed are all derived from the CAN data 49 of the vehicle 11 by the ECU 13. As shown in the above Table 1, the vehicle 11 initially travels from a starting position 0 to a distance of 0.5 km with an average speed of 115 KPH and a maximum speed of 120 KPH without making any turns. The vehicle 11 is traveling at the highest possible speed allowed by the government entity, which is known from the laws, regulations, and restrictions governing the country the vehicle 11 is traversing. These values are pre-programmed by a manufacturer of the vehicle 11, and are stored in a lookup table including data substantially similar to the final two columns of Table 1 (i.e., the context and global speed limit columns).

Based upon the vehicle 11 not completing any turns during the first 0.5 kilometers of distance traveled and having a relatively high average speed of 115 KPH and a maximum speed of 120 KPH, the context determination sub-engine 51 determines the context of the external environment to be a “highway” context with a Global Speed Limit (GSL) weight of 1.0 that is associated with a global speed limit 53 of 115 KPH. This is because the average speed of 115 KPH eclipses the thresholds or values associated with the other contexts, and the low number of turns indicates that the vehicle 11 was traveling in a straight direction.

During the period when the vehicle 11 travels from 0.5 km to 1.0 km, Table 1 depicts that the vehicle 11 makes a single turn, and maintains the same average speed of 115 KPH and has a matching top speed of 115 KPH. Thus, because the vehicle 11 maintains a relatively high average speed and top speed, the context determination sub-engine 51 determines that the context of the external environment is a “highway” context associated with a 115 KPH speed limit. However, because the vehicle 11 has made a turn during this travel segment, the context determination sub-engine 51 outputs a GLS weight of 0.9, as the context determination sub-engine 51 is aware that the context of the external environment may have changed as a result of the turn. In this regard, a “turn” represents a sustained non-zero steering wheel angle above a predetermined threshold set by a vehicle 11 manufacturer. For example, a vehicle 11 manufacturer may determine that a “turn” is defined to be anytime the steering wheel encoder 39 detects that the steering wheel 29 has been actuated more than 30 degrees from center.

Continuing with Table 1, for the third series of data corresponding to a distance segment of 1.0-1.5 km, the vehicle 11 makes an additional turn, such that the vehicle 11 has now completed two turns during the first 1.5 km of travel. The average speed of the vehicle 11 during this travel distance is 85 KPH, and the maximum speed is 115 KPH. The average speed falls below the maximum speed limit associated with a highway context (i.e., 115 KPH), but above the maximum speed limit associated with the next fastest context (i.e., a rural context with a maximum speed limit of 70 KPH). Thus, the context determination sub-engine 51 is aware that the context is likely to be either a highway context or a rural context, but is unsure of which context to output. The context determination sub-engine 51 experiences further confusion based upon the additional turn, which indicates that the vehicle 11 may have left the previously determined highway context.

On the basis of the above information, the context determination sub-engine 51 assumes that the vehicle 11 is attempting to slow down as a result of exiting a highway context and entering a rural context. As such, the context determination sub-engine 51 outputs a “rural” context associated with the external environment and having a global speed limit 53 of 70 KPH. However, due to the described sources of confusion for the context determination sub-engine 51, the output rural context is associated with a GSL weight of 0.2, which indicates that the context determination sub-engine 51 has nominal confidence in the output context.

The final row of Table 1 depicts that the vehicle 11 makes two additional turns and maintains an average speed of 70 KPH and a top speed of 72 KPH after the vehicle 11 has transitioned from the highway context to the city context. Because the average speed of the vehicle 11 is the same as the global speed limit for a rural context, and because the maximum speed is only slightly higher than the average speed, the context determination sub-engine 51 assumes that a rural context is still the correct context and maintains the 70 KPH global speed limit 53. However, because the context determination sub-engine 51 was previously unsure of the rural context, the output GSL weight has a value of 0.7. A value of 0.7 in this instance indicates that the context determination sub-engine 51 is more confident in its determination of a rural context than the previous context determination, but the context determination sub-engine 51 is not as confident in this value as it was for the previously determined highway context.

Thus, overall, the context determination sub-engine 51 enables the ECU 13 to determine a local context of the external environment based on the CAN data 49 of the vehicle 11. The local context is output with its associated GSL weight as a global speed limit 53 by the context determination sub-engine 51 to an arbitration sub-engine 55. Simultaneously, the local speed limit 47 is output by the imaging sub-engine 45 to the arbitration sub-engine 55, such that the arbitration sub-engine 55 receives both the local speed limit 47 and the global speed limit 53 captured during the same period of time or over a same distance. Similar to the imaging sub-engine 45 and the context determination sub-engine 51, the arbitration sub-engine 55 is formed of computer readable code written in a language such as C++, C#, Java, MATLAB, or Python, for example. Functionally, the arbitration sub-engine 55 serves to determine an arbitrated speed limit 57 based on the local speed limit 47 and the global speed limit 53 as discussed further below.

The process of determining an arbitrated speed limit 57 is initiated by the arbitration sub-engine 55 placing the values of the global speed limit 53 and the local speed limit 47 in a data table. Such a table is embodied, by way of a non-limiting example, as Table 2 produced below.

TABLE 2

| Dist. | LSL | LSL | GSL | GSL | ASL |
|---|---|---|---|---|---|
| (km) | (KPH) | Weight | (KPH) | Weight | (KPH) |
| 0-1.0 | 15 | 0.8 | 40 | 0.3 | 15 KPH |
| 1.0-2.0 | 15 | 0.6 | 40 | 0.7 | 40 KPH |
| 2.0-3.0 | 40 | 0.9 | 40 | 0.9 | 40 KPH |

From Table 2 it can be seen that the arbitrated speed limit 57 (i.e., “ASL” in Table 2) is a function of both the local speed limit 47 (i.e., “LSL” and “LSL Weight” in Table 2) and the global speed limit 53 (i.e., “GSL” and “GSL Weight” in Table 2). More specifically, Table 2 reflects an example where a vehicle 11 is exiting a parking lot (not shown) and the ASL is displayed to a driver throughout the exiting process. In the first row of Table 2, the vehicle 11 is traveling through the parking lot (not shown), which has a posted speed limit of 15 KPH. Thus, the LSL of Table 2 is 15 KPH, which is associated with an LSL Weight of 0.8 indicating that the imaging sub-engine 45 is relatively confident in the extracted local speed limit 47.

However, in the example provided by Table 2, the vehicle 11 is traveling faster than the thresholds for a parking lot context, and the context determination sub-engine 51 is unsure of the context of the external environment as a result. That is, for example, the vehicle 11 may be traveling at a speed of 35 KPH, despite the posted speed limit having a value of 15 KPH. As a result, the context determination sub-engine 51 outputs a city context associated with a 40 KPH global speed limit 53 having a GSL weight of 0.3. This is because the actual speed of the vehicle 11 is closer to a speed limit associated with a city context than a speed limit associated with a parking lot context. Because the vehicle 11 is only traveling slightly faster than the speed limit associated with the parking lot context, the context determination sub-engine 51 will output a relatively low confidence value of 0.3 for a determined city context.

By comparing the local speed limit weight with the global speed limit weight, the arbitration sub-engine 55 determines the arbitrated speed limit 57. More specifically, the arbitration sub-engine 55 outputs an arbitrated speed limit 57 that is the same as the local speed limit 47 or the global speed limit 53, based upon the derived speed limits and their associated weights. Continuing with the example provided in Table 2, based upon the local speed limit weight being 0.8 and the global speed limit weight being 0.3 the arbitration sub-engine 55 outputs an arbitrated speed limit 57 of 15 KPH, matching the local speed limit 47.

In the next instance of data (i.e., row 2 of Table 2 corresponding to a travel distance of 1.0-2.0 km), a new sign 27 has not been detected by the vehicle 11. Thus, the same local speed limit 47 determined previously is still applicable with a decreased weight of 0.6 due to the distance traveled since the last sign 27 detection. On the other hand, Table 2 depicts that the GSL weight has increased to 0.7, which represents that during this travel segment the CAN data 49 is more closely related to a specific context. Such a case reflects that the vehicle 11 has exited the parking lot (not shown), and is now traveling along a city street at a consistent speed of 40 KPH, which closely matches the predetermined values for a city context. As a result of the change of the weights of the global speed limit 53 and the local speed limit 47, the arbitrated speed limit 57 is output to be 40 KPH, matching the global speed limit. Thus, the arbitration sub-engine 55 gives preference to the global speed limit 53 output by the context determination sub-engine 51 over the local speed limit 47 provided by the imaging sub-engine 45.

The third row of Table 2 depicts, for a travel distance of 2.0-3.0 km, that the vehicle 11 detects a new local speed limit 47 from a new sign 27. The new local speed limit 47 has a value of 40 KPH and is associated with a weight of 0.9. The context of the external environment has not changed such that the CAN data 49 for this distance segment represents that the vehicle 11 has continued to travel in a relatively straight direction with minimal velocity changes. Thus, the global speed limit 53 is maintained as 40 KPH, and the confidence weight associated therewith has a value of 0.9 as well. Due to the local speed limit 47 matching the global speed limit 53, the arbitration sub-engine 55 outputs an arbitrated speed limit 57 of 40 KPH.

Accordingly, the above examples described in relation to Table 2 discuss potential ways that an ECU 13 may leverage the imaging sub-engine 45, the context determination sub-engine 51, and the arbitration sub-engine 55 to determine an arbitrated speed limit 57. The arbitrated speed limit 57 is output from the arbitration sub-engine 55 to a display 19, which is positioned in the cabin (not shown) of the vehicle 11 to depict the arbitrated speed limit 57 to the driver of the vehicle 11. Thus, as a result of the speed limit arbitration process discussed in relation to FIG. 2, the driver of the vehicle 11 is routinely apprised of a speed limit applicable to the external environment, even in cases where the context of the external environment cannot be determined or a sign 27 cannot be accurately detected.

The above discussed examples are not intended to limit the functions of the arbitration sub-engine 55, however. In this regard, and although not discussed above, the arbitration sub-engine 55 may give preference to either the local speed limit 47 or the global speed limit 53 based upon additional factors. For example, the arbitration sub-engine 55 may be configured to discount the local speed limit 47 (by decreasing the local speed limit weight) when the CAN data 49 reflects that the vehicle 11 has completed at least one turn in a city context. This is because city streets often have different speed limits, and turning from one street to the next may require a change in the local speed limit 47 as well. Accordingly, the arbitration sub-engine 55 is configured to adapt the weights associated with either or both of the local speed limit 47 and the global speed limit 53 to reflect specific driving situations in order to ensure the accuracy of an output arbitrated speed limit 57.

Turning to FIGS. 3A-3D, these Figures depict various examples of contexts associated with a vehicle 11. The examples provided in FIGS. 3A-3D are representative in nature, and are not intended to limit the functionalities of an ECU 13 of the vehicle 11 discussed above. For example, an ECU 13 may conclude that a vehicle 11 resides in a context not depicted in FIGS. 3A-3D, such as a parking lot context. In addition, values presented in relation to FIGS. 3A-3D may or may not correspond to real-world values. Similarly, the below examples should not be construed so as to place limits on which context an ECU 13 deems applicable to the vehicle 11 in real-world embodiments.

FIG. 3A depicts an example of a vehicle 11 traveling through a city context for a predetermined distance (e.g., 1 km). As shown in FIG. 3A, the vehicle 11 is positioned at the start of a travel path 61. Within FIGS. 3A-3D, the travel path 61 is representative of the route of the vehicle 11 while traversing the external environment and indicates the general shape of a paved surface 25 associated with a particular context. In addition, average speed markers 59 are placed adjacent to the travel path 61 to indicate the average speed of the vehicle 11 on a particular segment of the travel path 61. The average speed markers 59 represent an average speed of the vehicle 11 determined from CAN data 49, and are illustrative in nature. Similarly, maximum speed markers 63 are placed adjacent to the travel path 61 to indicate the maximum speed of the vehicle 11 during a particular segment of the travel path 61.

During the first segment of the travel path 61 the vehicle 11 is shown to have an average speed of 50 KPH as indicated by the uppermost average speed marker 59. In addition, the vehicle 11 has a maximum speed of 57 KPH for the first segment of the travel path 61 as indicated by the uppermost maximum speed marker 63. During the second segment, the vehicle 11 has a maximum speed of 50 KPH and an average speed of 45 KPH. During the third segment, which extends parallel to the first segment and is the lowermost segment of the travel path 61 depicted in FIG. 3A, the vehicle 11 has a maximum speed of 42 KPH and an average speed of 35 KPH. In the fourth segment, the vehicle 11 has a maximum speed of 42 KPH and an average speed of 40 KPH. During the fifth and final segment, the vehicle 11 has an average speed of 41 KPH and a maximum speed of 44 KPH. Because FIG. 3A depicts a travel path 61 as having five separate segments, the vehicle 11 makes four turns while traveling along the travel path 61.

Thus, the average speed of the vehicle 11 across all segments of the travel path 61 depicted in FIG. 3A ranges from 35 KPH-50 KPH, and the maximum speed of the vehicle 11 ranges from 42 KPH to 57 KPH. These speed ranges from the CAN data 49 of the vehicle 11 are subsequently compared to predetermined context thresholds, and the context determination sub-engine 51 concludes that the vehicle 11 is currently traveling through a city context. For example, an ECU 13 is aware of multiple contexts, and the most relevant contexts to the speeds of FIG. 3A may be a city context with a speed limit of 55 KPH and a rural context with a speed limit of 70 KPH. Thus, because the average speeds and the maximum speeds are closer to the speed limit associated with the city context, rather than the rural context, the context determination sub-engine 51 determines that the vehicle 11 is traveling through a city context. This determination is further reinforced by the relatively high number of turns for the predetermined distance (e.g., 4 turns over a distance of 1 km), and the context determination sub-engine 51 will output a high confidence value (i.e., greater than or equal to 0.7, for example) as a global speed limit weight.

Turning to FIG. 3B, this Figure depicts an example of a vehicle 11 traversing a parking lot context. As depicted in FIG. 3B, a travel path 61 of the vehicle 11 has five segments, similar to the travel path 61 depicted in FIG. 3A. Initially, the vehicle 11 travels the first segment of the travel path 61 with an average speed of 15 KPH and a maximum speed of 17 KPH, as depicted by the average speed marker 59 and the maximum speed marker 63, respectively. While the vehicle 11 is traveling on the second segment of the travel path 61, the vehicle 11 has an average speed of 10 KPH and a maximum speed of 11 KPH. During the third segment, the vehicle 11 has an average speed of 14 KPH and a maximum speed of 20 KPH, and during the fourth segment the vehicle 11 has an average speed of 12 KPH and a maximum speed of 15 KPH. During the final segment of the travel path 61 depicted in FIG. 3B, the vehicle 11 has an average speed of 16 KPH and a maximum speed of 17 KPH.

Thus, FIG. 3B depicts that the average speed of the vehicle 11 ranges from 10 KPH to 16 KPH, and the maximum speed ranges from 11 KPH to 20 KPH. By using a classification algorithm as discussed above, the context determination sub-engine 51 determines that the parking lot context is the correct context. This is because the average and maximum speed values are most closely related to a parking lot context, which has a speed limit of 15 KPH. In addition, the relatively high number of turns (i.e., four turns) taken by the vehicle 11 lends credence to the parking lot context determination, as it is less likely that such a relatively large number of turns would be taken in a rural context or a city context at the above discussed speeds.

FIG. 3C depicts an example of a vehicle 11 traversing a rural context. As shown in FIG. 3C, the vehicle 11 traverses a winding travel path 61 with an average speed of 67 KPH and a maximum speed of 70 KPH. FIG. 3C further depicts that the vehicle 11 makes two relatively small turns while driving along the travel path 61. Thus, the context determination sub-engine 51 determines that the vehicle 11 is traveling through a rural context, as a rural context is associated with a speed limit of 70 KPH and a low number of turns (i.e., two or less turns over a predetermined distance). That is, because the average speed, maximum speed, and number of turns captured by the average speed marker 59, the maximum speed marker 63, and the travel path 61, respectively, are closest to predetermined values associated with a rural context, the context determination sub-engine 51 determines a rural context to be the correct context for the external environment of the vehicle 11 with a relatively high confidence value (i.e., greater than or equal to 0.7).

Turning to FIG. 3D, FIG. 3D depicts that the vehicle 11 travels in a straight line, without turning, at an average speed of 115 KPH and a maximum speed of 123 KPH. Because the average speed and the maximum speed are similar to the speed limit associated with a highway context, the context determination sub-engine 51 determines that the context of the external environment is a highway context. In this case, the highway context has a speed limit of 115 KPH, and the global speed limit 53 output by the context determination sub-engine 51 will be 115 KPH with a relatively high confidence value.

As discussed above and in relation to FIGS. 3A-3D as a whole, based upon the determined context the vehicle 11 outputs a global speed limit 53 to an arbitration sub-engine 55. The arbitration sub-engine 55 proceeds to determine an arbitrated speed limit 57 based upon the confidence weights of the local speed limit 47 and the global speed limit 53, such that a speed limit with the highest confidence value is output as the arbitrated speed limit 57. In this way, the contexts depicted in FIGS. 3A-3D, which are determined based upon the CAN data 49 of the vehicle 11, allow the ECU 13 as a whole to determine a correct global speed limit 53, and subsequently determine an arbitrated speed limit 57.

Referring now to FIG. 4, FIG. 4 depicts a detailed overview of the physical hardware forming, in part, a vehicle 11 in accordance with one or more embodiments of the invention. As shown in FIG. 4, a vehicle 11 includes an ECU 13 that is connected to an image sensor 17, a display 19, a steering wheel encoder 39, a drivetrain encoder 41, and a governor 69. These components are connected to the ECU 13 by way of a data bus 15, which is a series of wires, optical fibers, printed circuits, or equivalent structures for transmitting signals between computing devices. Thus, the data bus 15 forms one or more transmitter(s) and receiver(s) between the various components described herein.

Structurally, the ECU 13 is formed by a processor 65 and a memory 67. The processor 65 is formed by one or more processors, integrated circuits, microprocessors, or equivalent computing structures that serve to execute computer readable instructions stored on the memory 67. Thus, the memory 67 includes a non-transitory storage medium such as flash memory, a Hard Disk Drive (HDD), a solid state drive (SSD), a combination thereof, or equivalent storage devices. In relation to the various Figures discussed above, the memory 67 stores the computer readable instructions forming the imaging sub-engine 45, the context determination sub-engine 51, and the arbitration sub-engine 55, and the functionalities associated therewith. The computer readable instructions are executed by the processor 65, such that the processor 65 executes the code forming the imaging sub-engine 45, the context determination sub-engine 51, and the arbitration sub-engine 55.

On the other hand, the image sensor 17 is embodied as a camera, a series of cameras, a LiDAR unit, or a radar unit, for example. The image sensor 17 captures image frames 43 of the external environment of the vehicle 11. The image frames 43 are transmitted to the ECU 13 by way of the data bus 15, and the ECU 13 processes the image frames 43 through the imaging sub-engine 45 to extract a posted speed limit from a sign 27 disposed in the external environment. Thus, the image sensor 17 is ultimately utilized, in conjunction with the imaging sub-engine 45 of the ECU 13, to determine a local speed limit 47 posted in the external environment of the vehicle 11.

The steering wheel encoder 39 and the drivetrain encoder 41 are each embodied, for example, as a magnet and hall effect sensor. The steering wheel encoder 39 is specifically embodied as a magnet attached to a steering wheel 29 of the vehicle 11, and the hall effect sensor is attached to a stationary portion of the vehicle 11 adjacent to the magnet, or vice-versa. The hall effect sensor measures changes in the strength of a magnetic field produced by the magnet. Thus, the magnet and hall effect sensor forming the steering wheel encoder 39 collectively transmit data to the ECU 13 representative of the angle of rotation of the steering wheel 29 by measuring the changes in strength of the magnetic field produced by the magnet. The drivetrain encoder 41 functions in a similar manner, but measures a number of rotations of a driveshaft 35 rather than the rotation angle of the steering wheel 29. The rotation angle of the steering wheel 29 corresponds to turn(s) taken by the vehicle 11, whereas the number of rotations of the driveshaft 35 corresponds to the velocity and distance traveled by the vehicle 11.

The data output by the steering wheel encoder 39 and the drivetrain encoder 41 is collectively referred to as CAN data 49 as discussed herein. As discussed above, the CAN data 49 is used by the context determination sub-engine 51 of the ECU 13 to determine a context of the external environment and a global speed limit 53 associated therewith. The global speed limit 53 is output by the context determination sub-engine 51 to the arbitration sub-engine 55, and the arbitration sub-engine 55 outputs an arbitrated speed limit 57 that matches either the received local speed limit 47 or the global speed limit 53 based on their associated confidence weights.

FIG. 4 also depicts that a vehicle 11 includes a display 19. The display 19 may be embodied, for example, as an Organic Light Emitting Diode (OLED) display, a Liquid Crystal Display (LCD) panel, or equivalent display devices in accordance with embodiments of the invention discussed herein. Functionally, the display 19 serves to present the arbitrated speed limit 57 to the driver of the vehicle 11. This allows the driver to be apprised of the arbitrated speed limit 57, rather than the local speed limit 47 or the global speed limit 53 outright.

Finally, FIG. 4 depicts that a vehicle 11 includes a governor 69. The governor 69 may be embodied, for example, as a throttle control device that limits the position of a throttle (not shown) of the vehicle 11. As the throttle (not shown) controls the amount of fuel provided to an engine (not shown) of the vehicle 11, the governor 69 controls the amount of power provided by an engine (not shown) of the vehicle 11. That is, because the engine (not shown) rotates the driveshaft 35 to actuate the vehicle 11, the throttle control provided by the governor 69 reduces the maximum speed of the vehicle 11. The governor 69 is specifically configured to control the throttle position in relation to the arbitrated speed limit 57 such that the driver of the vehicle 11 is prevented from exceeding the arbitrated speed limit 57. Alternatively, the governor 69 may limit the throttle position such that the vehicle 11 is capable of traveling at speeds a predetermined amount above an arbitrated speed limit 57. For example, if an arbitrated speed limit 57 is determined to match a global speed limit 53 of 70 KPH, the governor 69 may limit the vehicle 11 such that the vehicle 11 has a top speed of 75 KPH (i.e., 5 KPH greater than the global speed limit 53). In this way, the governor 69 controls the real world movement of the vehicle 11 according to the arbitrated speed limit 57 without driver input.

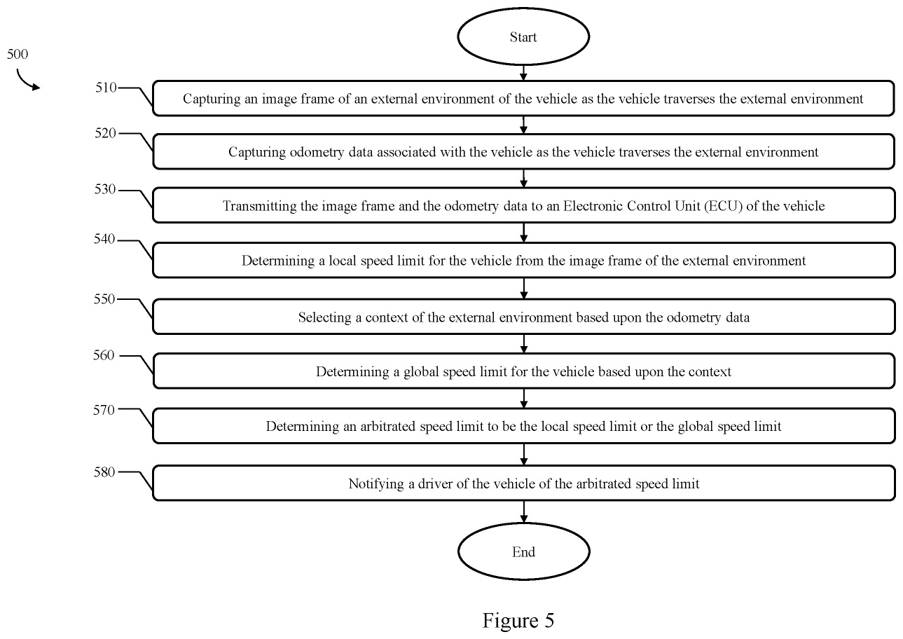

Turning now to FIG. 5, FIG. 5 depicts a method 500 for operating a vehicle 11 in accordance with one or more embodiments of the invention presented in this disclosure. Steps of FIG. 5 may be performed by a vehicle 11 as described herein, but are not limited thereto. Furthermore, the steps of FIG. 5 may be performed in any order, and the steps are not limited to the sequence presented. In addition, multiple steps of FIG. 5 may be performed as a single action, or one step may include multiple actions taken by components described herein.

Initially, in step 510, an image frame 43 of the external environment of the vehicle 11 is captured. During this step, the vehicle 11 is traversing the external environment, and an image sensor 17 captures an image frame 43 or series of image frames 43 of the external environment. The image sensor 17 includes a camera or a series of cameras positioned to capture images that include a sign 27. The sign 27 depicts information concerning a posted speed limit of the external environment, and this information is reflected in the images captured by the image sensor 17.

In step 520, odometry data related to the vehicle 11 is captured while the vehicle 11 is traversing the external environment. In particular, step 520 includes capturing a steering wheel 29 rotation angle with a steering wheel encoder 39 and capturing a number of rotations of a driveshaft 35 with a drivetrain encoder 41. The steering wheel 29 rotation angle and the number of rotations of the driveshaft 35 form CAN data 49 of the vehicle 11, which is the odometry data associated with the vehicle 11 discussed above. Thus, the odometry data represents the motion of the vehicle 11 through the external environment, as the steering wheel 29 rotation angle and the number of rotations of the driveshaft 35 directly correspond to the linear and angular velocity of the vehicle 11.

Because the image frame 43 captured in step 510 is also captured while the vehicle 11 is traversing the external environment, steps 510 and 520 may occur at the same time. Additionally, a period of time or predetermined distance where the odometry data is captured in step 520 may encompass a period of time or predetermined distance that an image frame 43 is captured in step 510. For example, odometry data (i.e., CAN data 49) may be captured for a predetermined period of time (i.e., 30 seconds), whereas an image of a sign 27 depicting a posted speed limit may be captured one or more times during the predetermined period of time or along a predetermined distance.

During step 530, the image frame 43 captured in step 510 and the odometry data captured in step 520 are transmitted to an ECU 13 of the vehicle 11. As discussed in relation to FIG. 4, the image sensor 17, the steering wheel encoder 39, and the drivetrain encoder 41 are operatively connected to the ECU 13 by way of a data bus 15. Accordingly, step 530 includes transmitting odometry data from the steering wheel encoder 39 and the drivetrain encoder 41 to the ECU 13, and transmitting the image frame 43 from the image sensor 17 to the ECU 13 over the data bus 15. The ECU 13 includes a processor 65 and a memory 67 that are configured to execute and store computer readable instructions forming the various sub-engines discussed above. Once the ECU 13 receives the odometry data (i.e., CAN data 49) and the image frame 43, the method proceeds to step 540.

Step 540 includes determining a local speed limit 47 for the vehicle 11 from the image frame 43 captured in step 510. During this step, the image frame 43 is input into an imaging sub-engine 45 stored on a memory 67 of the ECU 13. The imaging sub-engine 45 includes an Optical Character Recognition (OCR) function or a Convolution Neural Network (CNN) that processes the image frame 43 and extracts a local speed limit 47 therefrom. The local speed limit 47 includes a numerical value of a posted speed limit extracted from a sign 27 and a confidence weight, ranging from 0-1.0, inclusive, that mathematically represents a measure of certainty of the ECU 13 in the extracted speed limit.

During step 550, a context determination sub-engine 51 of the ECU 13 selects a context associated with the external environment. Specifically, the ECU 13 compares the odometry data to predetermined average speeds, maximum speeds, and a number of turns of the vehicle 11 to determine the context most closely associated with the external environment. To determine similarities between the odometry data and a particular context, the context determination sub-engine 51 may employ a classification algorithm such as K nearest neighbors or a SoftMax function. Alternatively, the context determination sub-engine 51 may be formed as a Recurrent Neural Network (RNN) that determines the context of the external environment based upon relationships learned during a training process. As another embodiment, the context may be determined according to predetermined thresholds associated with each potential context. Regardless of the method of determining the context, the context of the external environment is associated with a confidence weight related to the measure of certainty of the ECU 13 in the determined context. Once the context of the external environment is determined, the method proceeds to step 560.

In step 560, a global speed limit 53 is determined based upon the context determined in step 550. Each potential context of the external environment is predefined by a vehicle 11 manufacturer to be associated with a global speed limit 53. Thus, once the context is determined in step 550, the global speed limit 53 is determined to be the speed limit associated with the determined context. The potential contexts and their associated unique global speed limits are stored in the form of a lookup table on the memory 67 of the ECU 13, such that a lookup function is utilized to derive the global speed limit 53 from the determined context. Similar to the relationship between step 510 and step 520, steps 540-560 may be performed in tandem or separate, and a period of time when step 540 is performed may encompass a period of time when step 550 and step 560 are performed, or vice versa. After the global speed limit 53 is determined in step 560 and the local speed limit 47 is determined in step 540, the method proceeds to step 570.

Step 570 includes determining an arbitrated speed limit 57 to be either the local speed limit 47 or the global speed limit 53 with an arbitration sub-engine 55. In particular, this step includes forming a comparison, with the arbitration sub-engine 55, between the confidence weight associated with the local speed limit 47 and the confidence weight associated with the global speed limit 53, and outputting an arbitrated speed limit 57 that matches the speed limit with the highest confidence weight. In the event that a global speed limit 53 associated with a determined context and a local speed limit 47 have the same confidence weight value and different associated speed limits, the arbitration sub-engine 55 outputs an arbitrated speed limit 57 matching the lower speed limit for safety purposes.

Furthermore, the arbitrated speed limit 57 may be reset when predetermined conditions are met. For example, a new arbitrated speed limit 57 may be determined when the context of the external environment associated with a current arbitrated speed limit 57 changes or a new sign 27 is detected. Additionally, the confidence weight of the local speed limit 47 and the confidence weight of the global speed limit 53 may be discounted based upon various conditions being met. To this end, a confidence weight associated with a local speed limit 47 is discounted when the CAN data 49 indicates that the vehicle 11 has turned and the vehicle 11 is traversing a city context. Similarly, a confidence weight associated with a local speed limit 47 is discounted according to the distance between the vehicle 11 and the sign 27 as discussed above. Once an arbitrated speed limit 57 is determined, the method proceeds to step 580.

In step 580, a driver of the vehicle 11 is notified of the arbitrated speed limit 57. Specifically, this step includes transmitting the arbitrated speed limit 57 from the arbitration sub-engine 55 of the ECU 13 to the display 19 by way of the data bus 15. Once the display 19 receives the arbitrated speed limit 57, the arbitrated speed limit 57 is displayed to the driver. A display 19 is thus positioned in view of the driver, such as being embedded in the dashboard or being embodied as an infotainment module disposed in the cabin (not shown) of the vehicle 11. Consequently, the driver of the vehicle 11 is made aware of the arbitrated speed limit 57, which is useful in situations where a local speed limit 47 cannot be determined or is otherwise inaccurate.

Although only a few example embodiments have been described in detail above, those skilled in the art will readily appreciate that many modifications are possible in the example embodiments without materially departing from this invention. For example, the odometry data discussed above may include Global Positioning System (GPS) data concerning the orientation and motion of the vehicle. Furthermore, the context determination may be related to additional or alternative factors, such as the rotation speed of the engine or accelerometric data of the vehicle, rather than or in addition to the velocity of the vehicle 11 discussed above. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood to contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. A method for operating a vehicle, comprising:
capturing an image frame of an external environment of the vehicle as the vehicle traverses the external environment;
capturing odometry data associated with the vehicle as the vehicle traverses the external environment;
transmitting the image frame and the odometry data to an Electronic Control Unit (ECU) of the vehicle;
determining a local speed limit for the vehicle from the image frame of the external environment;
selecting a context of the external environment based upon the odometry data;
determining a global speed limit for the vehicle based upon the context;
determining an arbitrated speed limit as the local speed limit or the global speed limit, and notifying a driver of the vehicle of the arbitrated speed limit.

2. The method of claim 1, wherein the determination of the local speed limit further comprises: extracting the local speed limit from a speed limit sign captured in the image frame and assigning a first confidence weight to the local speed limit.

3. The method of claim 2, wherein the determination of the arbitrated speed limit comprises outputting the local speed limit or the global speed limit as the arbitrated speed limit based upon a comparison between the first confidence weight associated with the local speed limit and a second confidence weight associated with the global speed limit.

4. The method of claim 1, wherein the odometry data comprises velocity data and trajectory data of the vehicle.

5. The method of claim 4, wherein the trajectory data comprises data of a steering wheel angle of the vehicle.

6. The method of claim 4, wherein the trajectory data of the vehicle comprises a number of turns that the vehicle has made.

7. The method of claim 1, further comprising: governing a speed of the vehicle to be less than or equal to the arbitrated speed limit.

8. The method of claim 2, wherein the first confidence weight assigned to the local speed limit is decreased based upon a distance between the vehicle and the speed limit sign.

9. The method of claim 1, wherein the context of the external environment is selected from a group of contexts comprising: a parking lot context, a city context, a rural context, and a highway context.

10. The method of claim 9, wherein each context of the group of contexts is associated with a unique global speed limit.

11. The method of claim 9, wherein each context of the group of contexts is associated with a predetermined vehicle velocity and a predetermined number of turns of the vehicle.

12. The method of claim 1, further comprising determining a new arbitrated speed limit when the context associated with a current arbitrated speed limit changes.

13. The method of claim 1, further comprising determining a new arbitrated speed limit when a new speed limit sign is detected in the external environment.

14. A vehicle, comprising:
at least one image sensor configured to capture an image frame of an external environment of the vehicle as the vehicle traverses the external environment;
at least one encoder configured to capture odometry data associated with the vehicle as the vehicle traverses the external environment;
an Electronic Control Unit (ECU) of the vehicle configured to:
determine a local speed limit for the vehicle from the image frame of the external environment;
select a context of the external environment based upon the odometry data;
determine a global speed limit for the vehicle based upon the context, and
determine an arbitrated speed limit as the local speed limit or the global speed limit;
a display configured to notify a driver of the vehicle of the arbitrated speed limit, and
a data bus configured to transmit the image frame and the odometry data to the ECU.

15. The vehicle of claim 14, wherein the ECU is further configured to extract the local speed limit from a speed limit sign captured in the image frame and assign a first confidence weight to the local speed limit.

16. The vehicle of claim 15, wherein the ECU is further configured to output the local speed limit or the global speed limit as the arbitrated speed limit based upon a comparison between the first confidence weight associated with the local speed limit and a second confidence weight associated with the global speed limit.

17. The vehicle of claim 14, wherein the at least one encoder comprises a steering wheel encoder configured to capture trajectory data that includes data of a steering wheel angle of the vehicle.

18. The vehicle of claim 14, wherein the at least one encoder comprises a drivetrain encoder configured to capture velocity data related to a number of stops and a velocity of the vehicle.

19. The vehicle of claim 14, further comprising: a governor configured to control a speed of the vehicle to be less than or equal to the arbitrated speed limit.

20. The vehicle of claim 15, wherein the ECU is configured to decrease the first confidence weight assigned to the local speed limit based upon a distance between the vehicle and the speed limit sign.
